(19) United States
(12) Patent Application Publication
(10) Pub. No.: US 2010/0201505 A1
(43) Pub. Date: Aug. 12, 2010

(54) Occupancy Declaration/Verification For Passenger Transport Conveyances

(76) Inventors: Souroush Honary, Lancaster (GB); Michael Szczygiel, Richmond (GB)

Correspondence Address: HODGSON RUSS LLP;THE GUARANTY BUILDING, 140 PEARL STREET, SUITE 100, BUFFALO, NY, 14202-4040, US

(21) Appl. No.: 12/668,356

(22) PCT Filed: Jul. 9, 2008
(86) PCT No.: PCT/GB08/50552

§ 371 Date: Jan. 8, 2010

(30) Foreign Application Priority Data
Jul. 10, 2007 (GB) 0713336.6

(51) Int. Cl. B60Q 1/00; G06Q 10/00; G06Q 30/00; G06F 17/30

(52) U.S. Cl. 340/425.5; 705/34; 707/769; 707/705; 707/E17.014; 707/E17.044; 707/802

(57) ABSTRACT

The present invention relates to a secure method and enabling processes to: (1) through the use of personal nomadic communicators (PNCs) to automatically declare passenger occupancy in transport conveyances including but not limited to road vehicles, aircraft, trains, marine vessels, (2) monitor and assess the pattern of physical movements of passenger PNCs prior to, during, and after their use of such transport conveyances, (3) verify and record passenger occupancy based on such assessments and any suspicious patterns suggesting fraudulent declarations through the improper use and placement of PNCs not belonging to passengers, and (4) transfer occupancy data to management systems which utilise passenger occupancy as a factor in decision making including but not limited to determining occupancy related entitlements to the operators/owners/managers of transport conveyances.

### FIELD OF THE INVENTION

The present invention relates to a secure method and enabling processes to: (1) through the use of personal nomadic communicators (PNCs) to automatically declare passenger occupancy in transport conveyances including but not limited to road vehicles, aircraft, trains, marine vessels, (2) monitor and assess the pattern of physical movements of passenger PNCs prior to, during, and after their use of such transport conveyances, (3) verify and record passenger occupancy based on such assessments and any suspicious patterns suggesting fraudulent declarations through the improper use and placement of PNCs not belonging to passengers (4) transfer occupancy data to management systems which utilise passenger occupancy as a factor in decision making including but not limited to determining occupancy related entitlements to the operators/owners/managers of transport conveyances.

### BACKGROUND OF THE INVENTION

The UK government proposals for national road charge on a cost per mile (based on location and time) have not been well received by the public. In early 2007 ministers were taken by surprise at the strength of feeling against road pricing in the petition opposing the idea on the Downing Street web site. This has prompted a rethink of policy. The government has now come around to the view that to rescue its policy of reducing congestion by charging just by the mile it needs to offer incentives to drivers to opt into the system rather than forcing them to do so. Drivers will be offered a choice: carry on paying motoring taxes or switch to a road-pricing meter in the car that could save money. Road-pricing schemes with discounts for multiple occupancy, as well as lanes exclusively for use by high occupancy vehicles are being considered. The Transport Minister has been quoted as saying; “Anything that encourages car sharing and lowers the number of vehicles on a road must be welcomed.”

However, the perception of many motorists and especially those who commute daily to work is that any marginal benefits provided by ride sharing would not outweigh the convenience of travelling alone. Regrettably, this mentality only further fuels the problems of traffic congestion. Thus, in the interest of reducing traffic congestion, harmful pollutants (e.g., oxides of nitrogen, volatile organic compounds and carbon monoxide), and greenhouse gas emissions (e.g., carbon dioxide), automobile commuters need incentives to ride-share that make it worthwhile to give up the conveniences of single occupant vehicle commuting.

One obvious incentive is a reduction in road (congestion) charges. Other examples are priority status on the use of special high-speed High Occupancy Vehicle (HOV) lanes or convenient discounted parking in city centres. There is a multiplicity of possible incentive schemes that could be employed to promote ride sharing within the context of congestion charging systems at either a national or local (city) level. It is important to note that these schemes can be entirely voluntary. Those who wish to go solo may continue doing so but at a noticeable higher cost. (£1.50 per mile as opposed to say £1.00 per mile with 1 passenger or £0.75 with 2 passengers etc.).

Vehicle occupancy has so far been absent from the UK road-charging proposition The technical challenge is reliable verification of the number of vehicle occupants. Past studies show that any form of verification that depends on devices outside the vehicle (such as cameras) is inherently flawed. The experience in the USA shows that costly police enforcement is often lax and the fraudulent use of HOV lanes by solo drivers can be as high as 30%.

Two noteworthy studies in this field are: (1) Automated Vehicle Occupancy Monitoring Systems for HOV/HOT Facilities—Consultants report commissioned by the Ontario Ministry of Transport. (2) Automated Vehicle Occupancy Technologies Study, a 12-month project financially underwritten by the HOV Pooled Fund, a HOV development funding mechanism supported by numerous US State Departments of Transportation (DOTs) and the US Federal Highways Agency.

Automated Vehicle Occupancy Monitoring Systems for HOV/HOT Facilities. The Key findings of this study are: (1) Detecting occupancy from outside the vehicle is inherently flawed, solutions must start from inside the vehicle and build outwards, (2) Occupancy monitoring involves significant in-vehicle, roadside and back-office costs, (3) Some technologies are identified to address the problem of which two: mechanical systems and weight sensors are in use today.

Automated Vehicle Occupancy Technologies Study. The underling issue responsible for launching this project was the widespread consensus amongst HOV facility operators that vehicle occupancy verification is a principal impediment to more efficient HOV lane enforcement. The objective of this project is to identify, compile, and systematically evaluate concepts, methods, and technologies for automated vehicle occupancy detection, verification and enforcement that are being researched, under development and on the horizon in the United States and abroad. Findings will be used to assist in identifying, developing, and implementing cost-effective, automated techniques for verifying and enforcing vehicle occupancy to enable the offering of the high occupancy vehicle (HOV) preference in an effective way.

Two in-vehicle technologies of particular merit and promise are identified out of ten candidates, weight sensing (in seats) and 3D Time of Flight Imaging. However the report notes that a key disadvantage of weight sensing for HOV occupancy detection is that it can be fooled—meaning by simply placing weights on the seats “passengers” can be created which would seem to make it unsuitable for this application.

3D optical time of flight (TOF) imaging is a type of radar range measurement. It employs active sources (mostly lasers) that emit either short pulses or continuous wave modulated beams and evaluate the delay or phase shift of the beam reflected from a distant object. TOF based 3D sensors work reliably on textured and non-textured surfaces, they work regardless of the ambient lighting conditions, and they can be packaged in a small form. The key disadvantage of TOF Imaging is that it requires line of sight. In addition to TOF Imaging there are several technologies that use various forms of measuring changes in electromagnetic fields within the passenger compartment to detect vehicle occupancy.

These in-vehicle technologies for occupancy detection have been developed as a response to occupant safety concerning air bag deployment and the U.S. Federal Motor Vehicle Safety Occupant Crash Protection Standard (FMVSS 208) mandating the use of advanced or “smart” air bags in the front seats of new vehicles sold. A compliance of 35% is required for 2007 models. By 2009 and thereafter all vehicles must be equipped with smart air bags that deploy according to passenger size, weight and seating position. Occupancy detection systems are consequently a critical part of smart air bag systems. This is creating enormous financial incentives for researchers and represents a major investment by manufacturers. Although the Standard applies only to vehicles sold in the U.S. similar requirements may emerge in Europe and elsewhere.

From a road usage charging perspective it needs to be noted that with FMVSS 208 only the driver and front seat passenger would be detected. Second, any strategy based on new-vehicle equipage must cope with the fact that it takes about 20 years for 95% of the fleet to be replaced. What is required is a very low cost, easy to implement, in-vehicle, aftermarket solution that makes a compelling case for putting vehicle occupancy on the road usage charging agenda. Wireless communications technologies are well suited to provide such a solution.

GSM or CDMA are the technologies upon which mobile phones are based. Most modern phones today also incorporate Bluetooth short range communications. The use of mobile phones in society is pervasive. Market penetration for mobiles in the developed world is at or near saturation point, and the mobile phone is now taken as an everyday commodity which people carry with them wherever they go. This provides a basis for a future scheme for determining vehicle occupancy albeit with safeguards to prevent fraudulent use by the rogue drivers trying to beat the system (i.e. multiple phones in car but only one in occupant in reality, the driver, this being the electronic equivalent of putting weights on seats with weight sensors to fabricate “make believe” passengers).

System and method for facilitating ridesharing, —Paragraph [0056] of the Description of US Patent Application 20040049424 states “Location-based services could be coupled with the global positioning system, for example, sending relevant local retailer information to a mobile wireless device of a rideshare participant 104 during the trip. Location-based information may also be used to validate participant activity in ridesharing trips. For example, service provider 102 may track the location of participants using location-based services that monitor the mobile telephone location. Based on the location of the mobile telephones, the service provider 102 can determine if the participants traveled together along the stated ridesharing route.” This patent application describes a system which has three potential weaknesses regarding participant activity in ridesharing schemes through the use of mobile LBS tracking. First it does not address how the service provider could verify how many passengers were travelling together. This makes it inevitable that rogue operators would quickly defeat any system based on this rather thin and weak technological reed. Secondly, tracking individual mobile phones throughout a journey could be costly to the passengers offsetting any benefits to the driver. Thirdly it does not address short-range communications between the vehicle occupants' mobile phones and the vehicle on-board computer. Such communication is essential for implementing toll and road charging based on passenger occupancy.

Government and industry thinking to date has focused on the need to detect the number of occupants in a vehicle. There is another approach to be considered, Occupancy Declaration by the vehicle occupants (driver and passengers). On the face of it this would seem a naïve and impractical approach. As mentioned above, rogue drivers would attempt to create non-existent passengers and without a means of verifying what the driver claims as passengers such a system would quickly fall into disrepute.

This invention defeats rogue operators of transport conveyances who attempt to gain privileges/penury advantage in their use of transport infrastructure by creating fake passengers to trick occupancy based incentive systems for operators. It further aims to specify a secure and reliable method, apparatus and enabling processes using wireless communications technology for declaring and verifying occupancy in a passenger transport conveyance including but not limited to road vehicles, aircraft, trains and marine vessels. In example embodiments, passenger occupancy data that has been verified or tagged as suspicious is recorded and forwarded via wireless communications to an authority responsible for determining the occupancy related entitlements that operators/owners/managers of transport conveyances are eligible to receive. Embodiments of the invention incorporate techniques for the recognition of suspicious patterns over a period of time that would lead the relevant authority to investigate past claims by a transport conveyance operator/owner/manager. Based on the outcome of these investigations the authority would be able to (a) revoke the future operator/owner/manager entitlements, (b) recover past financial benefits from the operator/owner/manager, and (c) issue fines to the operator/owner/manager.

### SUMMARY OF THE INVENTION

According to the present invention there is provided an apparatus and method as set forth in the appended claims. Preferred features of the invention will be apparent from the dependent claims, and the description which follows. The present invention constitutes a secure method and enabling processes to: (1) automatically declare prior to the start of a journey the occupancy in passenger transport conveyances including but not limited to road vehicles, aircraft, trains, marine vessels, (2) confirm to the operator(s) of the transport conveyance the number of automatically declared passengers being carried prior to the commencement of the journey, (3) monitor and assess the location and movement pattern of passengers arriving prior to the start of the journey, during the journey and immediately after exiting the transport conveyance at the end of the journey, (4) identify suspicious occupancy declarations and adjust automatically declared occupancy as required (5) monitor and assess the pattern of passenger geographic dispersals over some defined period after the end of the journey, (6) verify that the pre-journey/post journey passenger movement patterns are consistent with the automatically declared (or adjusted) passenger occupancy, (7) communicate the verified passenger occupancy for each journey to a transport system usage billing and accounting system.

The enabling processes are embodied in six domains (1) on-board the transport conveyance, (2) transport conveyance operations support centre, (3) personal nomadic communicators (PNCs) carried by the transport conveyance occupants, such PNCs having wireless communications capability, (4) transport system usage service providers, (5) transport system usage—billing services providers, (6) transport conveyance owners/managers, (7) long range wireless communication networks.

On-board the transport conveyance—A secure embedded computer (SEC) within the transport conveyance manages the following processes (1) short range communication with occupant PNCs (up to 100 meters), (2) automatic pre-journey recognition of occupant PNCs. (3) assessment of pre-journey, in-journey, post journey movement data received from occupant PNCs (4) long range communication with the Transport Conveyance Operations Support Centre, (5) long range communication with the Transport System—Billing Service Provider. Within the SEC resides a module that can perform a first level verification of the occupancy based on the assessment of occupant PNC location and movement patterns. Based on this it generates an occupancy manifest that is communicated to the Transport Conveyance Operations Support Centre. This manifest includes confidence levels of the veracity of the declared occupancy. Low confidence levels may cause the Transport Conveyance Operations Support Centre to reject the occupancy declaration outright or scrutinise it more closely.

The Transport Conveyance Operations Support Centre includes an Occupancy Verification System that performs a second level occupancy verification to identify patterns of location and movement of passenger nomadic communicators (PNCs) that are inconsistent with what could be expected of people. The purpose is to detect fraudulent handling of PNCs by transport conveyance operators to acquire passenger occupancy travel entitlements/penury benefits illegally.

Passenger Nomadic Communicators—Such devices include but are not limited to mobile phones and PDAs enabled with short range communications capability of up to 100 meters including but not limited to Bluetooth, Ultra Wide Band (UWB) extensions of Bluetooth and other UWB enabled nomadic devices.

Billing Services—This includes a database of registered transport conveyances and transport system users. This database would contain all transport conveyances registered to receive occupancy related entitlements related to the use of the relevant transportation system. It would also contain the registration of all operators of those conveyances and regular passengers who use those conveyances. Registered operators and regular passengers would be registered for specific transport conveyances. Non-registered passengers are treated as guests.

Transport Conveyance Owners/Managers—These are parties having legal responsibility for the care and operational management of the transport conveyance.

Long Range Wireless Communication Networks would include but are not limited to those using GSM and CDMA mobile standards as well as networks using satellite communications.

On-board the transport conveyance, short-range communication with passenger nomadic communicators—The SEC would be enabled to recognise and pair up with occupant PNCs (if they are switched on) when the devices are within a range of up to 100 meters. If a PNC is not switched on the transport conveyance operator can request that it be so that the operator/owner/manager of the transport conveyance can acquire the occupancy-related entitlement for this journey.

On-board the transport conveyance, pre-journey registration of passengers—The SEC would maintain a list of PNCs belonging to regular passengers (such as daily commuters). In the case of mobile phones the identity of the PNC would be provided via the SIM card. Where a new PNC is detected the owner would be treated as a “guest”. When the transport conveyance is ready for departure, the passenger “manifest” is recorded. An operator(s) is always assumed and the occupancy count adjusted accordingly. There may be cases where the operator identity is required and this can be accomplished via a PNC belonging to the operator or via entry of a unique ID code by the operator on a fixed input device within the transport conveyance.

On-board the transport conveyance, assessment of pre-journey movement data received from passenger PNCs—The SEC can be used to detect a combination of the received signal strength, time of arrival and angle of arrival from each PNC and using this information can assess the proximity and place of the PNC. For instance, when the door is opened this may be seen as a sudden jump in signal strength. Hence by using propagation patterns, the passenger authentication module in the SEC can perform a first level assessment of whether the patterns are consistent with the normal pre-journey movement behaviour of passengers as they approach and enter a designated type of transport conveyance. Once the journey is underway the spatial relationships of the PNCs to each other can be determined. Current state of the art solutions for ad-hoc positioning indicate that short range wireless communications, including but not limited to Bluetooth, UWB and wireless LAN, can provide a relative positioning CEP P50 accuracy of 1 m. Crude attempts by the transport conveyance operator to switch on a couple of PNCs to create fake passengers would be readily detected. In a particularly preferred embodiment, a secondary assessment of PNC movement and location may be employed to identify more sophisticated pre-journey ploys by operators. Patterns that appear suspicious based on the data received from the PNCs at the SEC are earmarked as requiring deeper analysis by the Level 2 Occupancy Verification System (OCS) in the Transport Conveyance Operations Support Centre.

On-board the transport conveyance, assessment of pre-journey movement data received from passenger PNCs—The SEC may also be used to identify clusters of GSM nomadic devices, and provide a CEP P50 accuracy of up to 50 meters using enhanced wireless network position localisation tools, including but not limited to techniques such as Uplink Time Difference of Arrival, Angle of Arrival, Extended Cell-ID and modified GPS based techniques. With such position localisation tools clusters of PNCs could be tracked throughout a journey in regard to their relative position to each other without reference to absolute geographical position. However, this approach would ideally require communication between the PNCs and a tracking centre on a frequent basis throughout the journey, thus adding significant cost. In example embodiments post journey position localisation is used as a first position assessment strategy to determine the dispersal patterns of PNCs belonging to transport conveyance occupants going their separate ways after the journey. See paragraph [0030]. In example embodiments the Level 2 assessment is performed when the Level 1 assessment arouses suspicion, thereby minimizing reliance on external communication networks and associated positioning techniques.

On-board the transport conveyance, long range communication with the Transport Conveyance Operational Support Centre—At the end of journey the SEC transmits the usage of transport system by the transport conveyance together with the occupant manifest (with in-journey adjustments, corrections and Level 1 verification confidence levels) to the Transport Conveyance Operations Support Centre. Where communication may be blocked due to physical circumstances, the communication of the occupant manifest is queued until communication is possible. The transport system usage includes but is not limited to; the distance traveled, routes taken, time of day taken, condition of the route and so forth. However the SEC can use formulas to convert such information into a simple number representing units of transport capacity consumed and just transmit this number and the occupant manifest.

Occupancy Verification System (OVS)—The OVS scrutinises occupant manifests with Level 1 assessment confidence ratings below a preset level. For those having such low confidence ratings, additional backup data will be provided by the SEC. The computing power available to the OVS in conducting this Level 2 assessment allows the use of more sophisticated Artificial Intelligence (AI) algorithms, including but not limited to neural networks and fuzzy logic reasoning concepts that may be used to detect suspicious movements of PNCs indicating the likelihood of fake passengers being created by a rogue operator.

OVS, Post Journey Occupancy Verification—When passengers exit the vehicle they most often go their separate ways. Of course families, friends and sometimes co-workers may stay together (shopping, attending a sporting, cultural social event, working in near proximity in an office are examples). For each transport conveyance a profile of post-journey geographical (longer range) dispersion patterns of occupant PNCs can be developed over time. Statistical norms can be established for different classes of occupants, for example those who commute to work on a daily basis and rideshare with other commuters. Such commuters would likely opt to be registered users for one or more transport conveyances used in their ridesharing arrangements. Using refined localisation positioning including but not limited to techniques such as Uplink Time Difference of Arrival, Angle of Arrival, Extended Cell-ID and modified GPS based techniques suspicious dispersion patterns can be detected and reported to the Transport System Usage Service Provider if required.

OVS, Post Journey Occupancy Verification—For example, an operator seeking to “beat the system” could acquire one or more PNCs registered in different names with the Transport System UsageService Provider and simply put them in the transport conveyance when embarking on a journey. When these PNCs are switched on the SEC would and record the presence of “passengers” in the occupancy manifest. In this way a rogue driver could attempt to illegally obtain entitlements/penury advantages related to the passage of the operator's transport conveyance through the transport system. However, at the end of the journey the operator is faced with an awkward problem: how to geographically disperse the fake passengers PNCs so as to make it appear that they belonged to “passengers” who were going their separate ways or make it appear that it was a group of friends or family attending an event or shopping together. The amount of time and effort required to beat the system would challenge even the most determined rogue operator as the long range wireless network position localiser tool would be capable of assessing suspicious patterns in a few milliseconds. In practical operational terms those operators tempted to trick the system would come to accept that the financial gain was not worth their time and effort. Where a suspicious pattern is detected further investigate or processing techniques for example AI techniques can be applied, and if fraud is suspected the operator could be issued a “yellow card” caution. If the suspicious pattern persists the operator's or transport conveyance owner's/manager's entitlements would be suspended or revoked and penalties applied.

OVS, Post Journey Occupancy Verification—A rogue operator trying to beat the system could argue that the nature of the passengers relationship to each other is such that there is no post journey dispersal of their PNCs (for example commuters who work in the same office). Investigations into the veracity of the operator's claim could be costly, time consuming, and invade privacy. However random localisation checking of the PNCs over a period of some weeks could readily confirm one of the following suspicious patterns:
a. The PNCs are ALWAYs in close proximity
b. Never do both PNCs disperse concurrently from each other and their default post journey destination (either home or office). It could be argued that to overcome this, the operator could give the fake passenger device to a family member to carry with them in the evenings or weekends thus ensuring concurrent dispersion. This might work at home but is much more problematical at the office. At the end of the day its not worth the time and bother
c. When the PNCs disperse one is always left in the transport conveyance whilst stationary in one place for several hours at a time.

OVS, Post-Journey Occupancy Verification—A few borderline cases will occur and it becomes the responsibility of operators who have been given a yellow card caution to show evidence of compliance. Without such evidence the operator's/owner's/manager's transport conveyance(s) will not qualify for occupancy entitlements. As described herein, embodiments of the invention provide a technically viable, operationally practical and economic solution to the problem of passenger occupancy verification including but not limited to road vehicles, aircraft, trains and marine vessels.

OVS, Post Journey Occupancy Verification—The localisation approaches used by this invention to assess PNC dispersal after a journey are used in a way that only determines the relative position of PNCs to each other and to the transport conveyance, not their specific geographical locations other than the registered home and place of work locations. It does not track the routes taken during the course of the journey. Those who forget to turn on their phone or forget their phone will only cause the operator/owner/manager to lose the benefit of their occupancy for that particular journey.

Embodiments of the invention provide a highly secure and robust system for declaring and verifying passenger occupancy thus incentivising transport conveyance owners, managers and operators toward patterns of transport activity that can improve the performance of the transport system. Those who object on the principle of invasion of privacy are not obliged to participate and they will pay “full fare” without any collateral entitlements for their use of the transport system.

Embodiments of the invention find application in, for example:
Road tolling for vehicles in its various forms including but not limited to: congestion charging, Time Distance Place (TDP) road usage charging, entry into cordon/barrier controlled areas or throughways
High Occupancy Vehicle (HOV) lane operations in its various forms including HOT lanes
Entitlement to vehicle parking discounts/privileges
Emergency services vehicle occupancy notification
Carbon footprint tracking
Car pool/van pool management accounting
Dynamic route planning for private ridesharing vehicles
Passenger booking and dynamic route planning for commercial minibuses
Traffic junction control based on level of occupancy in vehicles approaching or waiting at the junction. For example traffic light timings would favour a fully loaded bus over a single car with one occupant waiting to cross.

### BRIEF DESCRIPTION OF THE DRAWINGS AND NOMENCLATURE ORGANISATION

Embodiments of the invention may take physical form in certain parts and steps and arrangements of parts and steps. The example embodiments are described in detail in this specification and illustrated in the accompanying drawings. A hierarchical nomenclature is used throughout the figures with the top level referring to Domains: Vehicle 01, Vehicle Operations Support Centre 02, Vehicle Occupants 03, Customer Service Providers 04, Billing Services 05, Vehicle Owner/Manager/Operator, Long Range Wireless Network. Thus a reference to the Vehicle Domain in FIG. 2 would be indicated by the number 201. A reference to the Road Usage Service Provider (one of the class of Customer Service Providers) in FIG. 2 would be indicated by the number 204 and so forth. Beneath Domains the levels of the hierarchy are Systems, Modules and Sub-Modules. Starting at the bottom of the hierarchy a Sub module 2 belonging to a Module 4b within a System 1 belonging to Domain 1 in FIG. 3 would be designated as 301.1.4b.2 and so forth. Table 1 describes the complete nomenclature organisation used in the description of this invention.

FIG. 1 shows the overall operational domains of an embodiment of the invention and their interrelationship;

FIG. 2 shows pre-journey functional modules related to the vehicle journey/driver authentication;

FIG. 3 shows pre-journey functional modules related to the passenger authentication and occupancy declaration (i.e. the passenger manifest);

FIG. 4 shows an ad-hoc network of passenger mobile phones that can be used to help establish their physical interrelationship;

FIG. 5 shows the post-journey assessment the dispersal patterns of vehicle occupant mobile phones using long range wireless network localisation as a means of verifying questionable occupancy declarations based on short range mobile phone signal processing in and near the vehicle; and

FIG. 6 shows the four stages of a journey where vehicle occupancy Level 1SEC screening can be used.

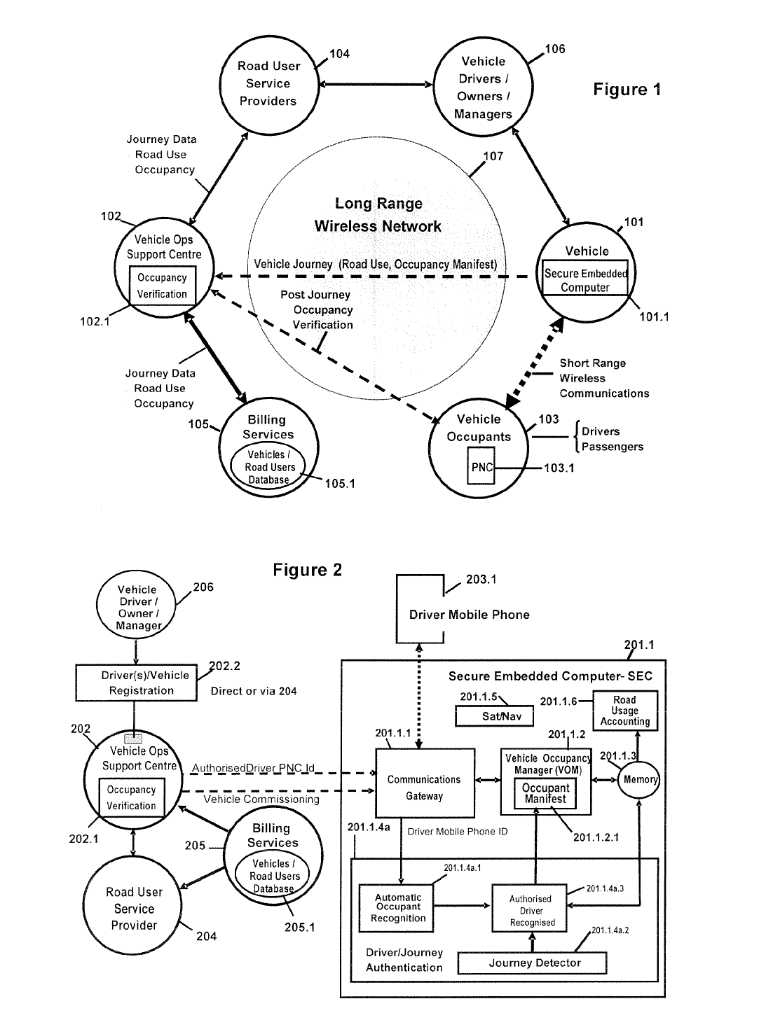

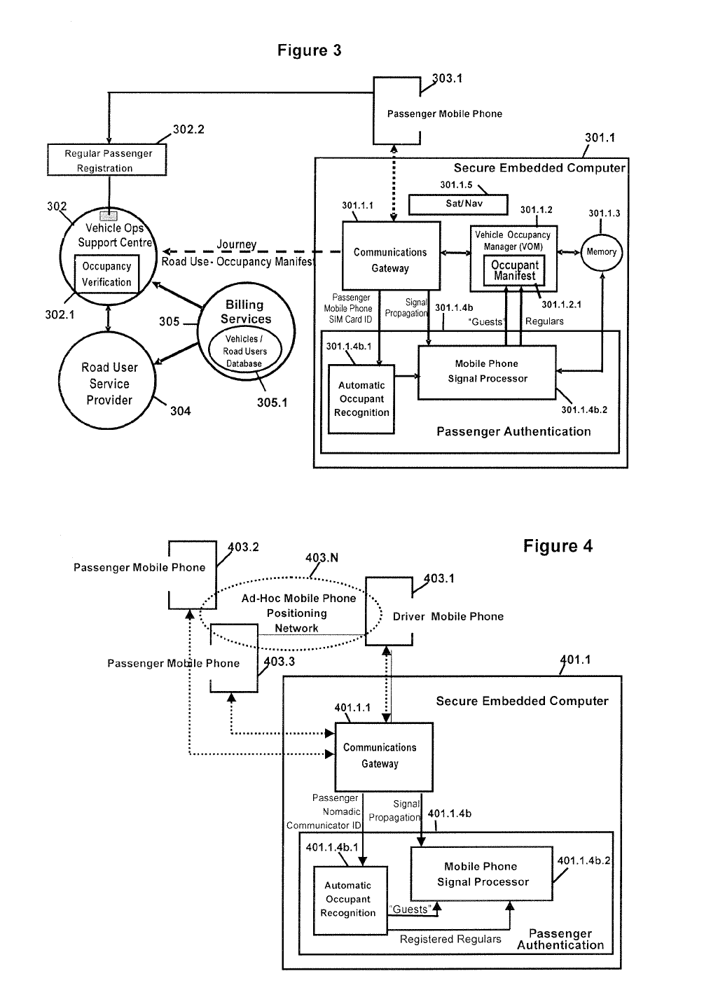

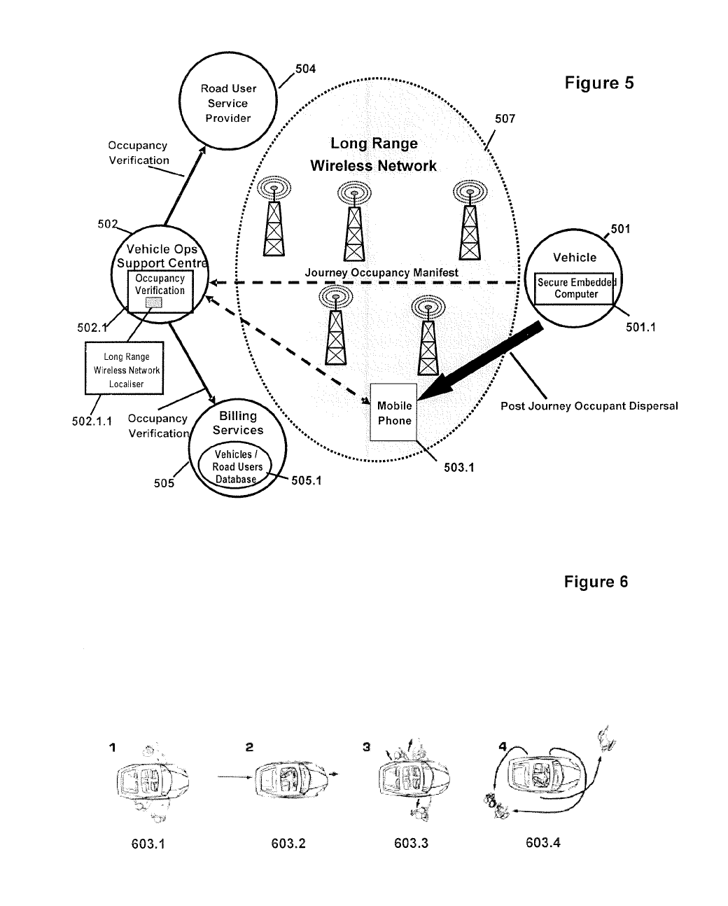

TABLE 1
Figures Nomenclature

| Domain | System | Module | Submodule | FIG. 1 | FIG. 2 | FIG. 3 | FIG. 4 | FIG. 5 | FIG. 6 |
|---|---|---|---|---|---|---|---|---|---|
| Vehicle | | | | 101 | | | | 501 | 601.1-.4 |
| | SEC | | | 101.1 | 201.1 | 301.1 | 401.1 | 501.1 | |
| | | Communications | | | 201.1.1 | 301.1.1 | 401.1.1 | | |
| | | Gateway | | | | | | | |
| | | Vehicle Occupancy | | | 201.1.2 | 301.1.2 | | | |
| | | Mgr | | | | | | | |
| | | | Occupant Manifest | | 201.1.2.1 | 301.1.2.1 | | | |
| | | Memory | | | 201.1.3 | 301.1.3 | | | |
| | | Driver/Journey | | | 201.1.4a | | | | |
| | | Authentication | | | | | | | |
| | | | Automatic Occupant | | 201.1.4a.1 | | | | |
| | | | Recognition | | | | | | |
| | | | Journey Detector | | 201.1.4a.2 | | | | |
| | | | Authorised Driver | | 201.1.4a.3 | | | | |
| | | | Recognised | | | | | | |
| | | Passenger | | | | 301.1.4b | 401.1.4b | | |
| | | Authentication | | | | | | | |
| | | | Automatic Occupant | | | 301.1.4b.1 | 401.1.4b.1 | | |
| | | | Recognition | | | | | | |
| | | | Mobile Phone Signal | | | 301.1.4b.2 | 401.1.4b.2 | | |
| | | | Processor | | | | | | |
| | | Sat/Nav | | | 201.1.5 | 301.1.5 | | | |
| | | Road Use Acctng | | | 201.1.6 | | | | |
| Vehicle Ops | | | | 102 | 202 | 302 | | 502 | |
| Support Ctr | Occy Verification | | | 102.1 | 202.1 | 302.1 | | 502.1 | |
| | System | | | | | | | | |
| | | Network Position | | | | | | 502.1.1 | |
| | Driver/Veh/ | | | | 202.2 | 302.2 | | | |
| | Pass Reg. | | | | | | | | |
| Occupants | | | | 103 | | | | | |
| | Mobile Phone | | | 103.1 | 203.1 | 303.1 | 403.1-.N | 503.1 | |
| Service Provider | | | | 104 | 204 | 304 | | 504 | |
| Billing Servies | | | | 105 | 205 | 305 | | 505 | |
| | Database Vehicles | | | 105.1 | 205.1 | 305.1 | | 505.1 | |
| | Road Users | | | | | | | | |
| Vehicle Driver/ | | | | 106 | 206 | | | | |
| Owner/Mgr. | | | | | | | | | |
| Long Range | | | | 107 | | | | 507 | |
| Wireless Network | | | | | | | | | |
| | Wireless | | | | | | | 507.x | |
| | Base Stations | | | | | | | | |

### EXAMPLE EMBODIMENTS OF THE INVENTION

In the following detailed description of exemplary embodiments of the invention, reference is made to the accompanying drawings (where the element numbers follow the scheme given in the nomenclature table), which form a part hereof, and in which is shown by way of illustration specific exemplary embodiments in which the invention may be practiced. These embodiments are described in sufficient detail to enable those skilled in the art to practice the invention, but other embodiments may be utilised and logical, mechanical, electrical and other changes may be made without departing from the scope of the present invention. The following detailed description is, therefore, not to be taken in a limiting sense, and the scope of the present invention is defined only by the appended claims.

Definition—The terms and acronyms defined in paragraphs [0041] to [0061] are used throughout this detailed description of the Preferred Embodiment of this invention. These definitions do not limit variations that would be used in other embodiments, such variations being known and accepted to those practiced in the technological arts used in this invention.

Authorised Driver—For each vehicle registered in the Vehicles and Road Users Database one or more drivers will be authorised to drive the vehicle. This authorisation is registered by the party with legal responsibility for the care and operation of the vehicle.

Automatic Occupant Recognition (AOR)—This refers to the means by which vehicle occupants are identified via short range communications with their Bluetooth enabled mobile phones that are in a near proximity to a vehicle, entering the vehicle or within the vehicle. Occupants are recognised in one of the following categories: authorised driver, registered passenger, unknown passenger (aka guest passenger).

Base Stations—In radio communications, a base station is a wireless communications station installed at a fixed location and used to communicate as part of either: (a) a push-to-talk two-way radio system, or (b) a wireless telephone system such as cellular CDMA or GSM.

Bluetooth—an industrial specification for wireless personal area networks (PANs). Bluetooth provides a way to connect and exchange information between devices such as mobile phones, laptops, PCs, printers, digital cameras, and video game consoles over a secure, globally unlicensed short-range radio frequency. The Bluetooth specifications are developed and licensed by the Bluetooth Special Interest Group.

Communications Gateway—A communications gateway is a device that connects two computer networks that use different protocols. It translates between protocols so that computers on the connected networks can exchange data. For example, commercial online services often have gateways for sending email to Internet addresses.

Geofence—A virtual boundary described by latitude/longitude co-ordinates at a preset distance from the current lat/long co-ordinates of a stationary vehicle in a parked condition. Common practice is to express this distance as a radius in meters.

Guest Passenger—A passenger who is not registered as a regular passenger of a particular vehicle. However a guest passenger may travel in several vehicles on an ad-hoc basis as a guest but be registered as a regular passenger in one or more others. Thus such a passenger would appear as a registered road user in the database of registered vehicles and road users.

In-Car/Near-Car Communications refers to short range wireless communications between a Bluetooth enabled mobile phone or PDA and an embedded in-vehicle computer at distances of up the maximum range of Bluetooth.

Journey—Any movement of the vehicle with its engine running from its parked sate beyond the geofence related to the latitude/longitude co-ordinates of its parked location. A journey is considered ended when the vehicle is in a stationary state, with the engine off, and no driver is detected as being present.

Localisation—This refers to techniques to establish the geographical location of a mobile phone.

Occupancy Manifest—Once a journey is underway, the occupancy manifest is created is and modified as needed journey during the course of the journey. Any changes to occupancy during the journey due to passenger pickup and drop-offs are recorded. At the end of the journey the occupancy manifest for the journey is Declared (i.e. transmitted to the Vehicle Operations Support Centre)

Personal Nomadic Communicator PNC—In the first embodiment of the invention this refers to a Bluetooth mobile phone or communications enabled PDA (Personal Digital Assistant). Other embodiments include but are not limited to active and passive RFID devices that can be embedded in clothing, personal accessories, or attached to or embedded within inanimate objects of a non-personal nature.

Registered Vehicle & Road Users Database—This is a database that includes (1) all vehicles and authorised drivers of those vehicles registered with the Road Charging Service Provider, (2) all regular passengers and which vehicles their regular passenger status applies to.

Regular Passengers—Regular passengers are those who register with the Vehicle Operations Support Centre. Typical regular passengers are those who participate in ridesharing schemes of the type organised by daily commuters.

Road User Service Provider (RUSP)—In this embodiment of the invention this would be one or more local or national public sector agencies and/or private sector organisations sanctioned by the government to operate a road charging/congestion charging service in a designated area or nation-wide market. Other embodiments of the RUSP can include but not be limited to insurance providers, parking management service providers, fleet management service providers and traffic management service providers

SAT/NAV refers to the in-vehicle devices that determine their location (longitude, latitude and altitude) to within a few meters using time signals transmitted along a line of sight by radio from a system of satellites orbiting the earth at a very high altitude that transmit continually. In addition to determining location these devices provide mapping facilities to display the vehicle location to the driver

Secure Embedded Computer (SEC)—This is a multi-application computer embedded in the vehicle to protect against tampering and hacking. It would house the in-vehicle road usage application and communicates road usage as required to the Vehicle Operations Support Centre. The second key application it runs is the Vehicle Occupancy Manager (VOM) which maintains the occupant manifest throughout the journey and declares occupancy to the Vehicle Operations Support Centre at the end of the journey. The SEC incorporates telematics modules known to those who practice the art that includes but is not limited to a communications gateway for long range and short-range communications and satellite navigation. It also includes modules for automatic recognition of occupants' mobile phones and a software module journey/driver/passenger authentication that uses signal processing of short range Bluetooth signals emanating from the mobile phones of drivers and passengers.

Signal Processing is the analysis, interpretation and manipulation of signals. Signals of interest in the context of this embodiment of the invention are those emitted by Bluetooth mobile phones. Processing of such signals includes storage and reconstruction, separation of information from noise and feature extraction such as angle and strength. Processing is done by software running on the SEC.

Ultra Wide Band (UWB) refers to any radio technology having bandwidth the lesser of 500 MHz or 20% of the arithmetic centre frequency, according to Federal Communications Commission (FCC).

Vehicle Operations Support Centre (VOSC)—This is a facility that may be standalone or part of the Road Charging Service Provider (RCSP). In either case it is closely linked with the day to day operations of the RCSP. The VOSC is charged with the responsibility of verifying vehicle occupancy declarations. It has two key roles in this embodiment of the invention (1) verifying individual journey declarations and rejecting those that appear to be suspicious using analytical tools applied to declarations with low confidence levels that have been determined by the Vehicle Occupancy Manager (VOM), and (2) Identifying patterns of journey declarations by vehicles whose aggregate statistical profile is highly suspicious.

Wireless Communications—is the transfer of information over a distance without the use of electrical conductors or “wires”. The distances involved may be short (a few meters as in television remote control) or very long (thousands or even millions of kilometres for radio communications). When the context is clear the term is often simply shortened to “wireless”.

Referring now to the drawings, wherein the drawings are for purposes of illustrating the example embodiments of the invention only and not for purposes of limiting same. The FIGS. 1-6 show an apparatus, method and enabling processes for the secure declaration and verification of transport vehicle occupancy, such occupancy referring to but not limited to human beings, animals and inanimate objects.

FIG. 1, Domains—This shows the domains used in explanation of embodiments of the invention: Vehicle 101, Vehicle Operations Support Centre 102, Vehicle Occupants 103, Road User Service Provider 104, Billing Services Provider 105, Vehicle Owners/Managers 106, and Long Range Wireless Network 107. Within the Vehicle Domain resides the Secure Embedded Computer (SEC) 101.1. Within the Occupant's Domain 103 reside one or more Personal Nomadic Communicators 103.1. In the first embodiment of this invention 103.1 is a Bluetooth enabled mobile phone or a communications enabled PDA (Personal Digital Assistant), and 107 is a GSM mobile phone network. Domains 102,104 and 105 may be physically or organisationally co-related or physically and/or organisationally separate.

FIG. 1, Secure Embedded Computer (SEC) 101.1—In the first embodiment of this invention this is a microprocessor of a capability recognised by those well practiced in the art of telematics to support road usage charging in its various derivative forms. The design and installation of the SEC is such to make it highly resistant to tampering with and hacking into. Its architecture is such that it can be upgraded with hardware and software add-ons to support the detection, declaration and verification of vehicle occupants qualified by levels of verification confidence.

FIG. 1, Vehicle Operations Support Centre (VOSC) 102—The VOSC registers drivers and what vehicles they are authorised to drive. It also registers regular passengers and what vehicles they regularly travel in. Registered drivers and registered regular passengers are designated as Registered Road Users. Associated with each registered road user are the SIM card details of their Bluetooth mobile phone 103.1. A primary function of the VOSC 102 is to verify that the declared vehicle occupancy for a declared journey is correct. It does this by analysing journey occupant manifests with low or borderline confidence levels as determined by short range wireless signal processing algorithms in the Secure Embedded Computer 101.1 in combination with the analysis of the geographical pattern of dispersal of occupant's mobile phones 103.1 after the journey. The verification process can involve reference to the Registered Vehicle & Road Users Database 105.1. Non-registered passengers who carry a Bluetooth mobile phone 103.1 detected by the SEC 101.1 are treated as “guest” passengers for the purposes of occupancy declaration. Once verified, the journey vehicle occupancy and road usage data sent to a Road User Service Provider 104 and the Billing Services Provider 105.

FIG. 1, Short Range Wireless Communications, SEC 101.1 < > Bluetooth Mobile Phone 103.1—In the preferred embodiment of this invention short range wireless communications will be provided via Bluetooth 2 and follow-on UWB (Ultra Wide Band) variants of Bluetooth.

FIG. 1, Wide Area Wireless Communications, SEC 101.1 < > VOSC 102 < > GSM Mobile Phone 103.1—In the preferred embodiment of this invention wide area wireless communications will be provided by GSM public networks or the like.

FIG. 2, SEC 201.1, Modules—The SEC system comprises five modules: (1) Communications Gateway 201.1.1 that handles wide area wireless communications with the remote VOSC 202 and short range wireless communications with in-vehicle/near-vehicle Bluetooth mobile phones 203.1, (2) Vehicle Occupancy Manager 202.1.2 that manages all information related to occupancy including the compilation of occupancy manifest confidence levels for each journey annotated with automatic occupancy declarations detected as being suspicious, (3) Memory 201.1.3 for recording occupancy manifests (past, current and present) related to journeys taken by the vehicle, (4) Driver/Journey Authentication 201.1.4a for recognising the authorised driver of the vehicle and updating the occupancy manifest as passengers enter and leave the vehicle during the course of the journey, (5) Sat/Nav 202.1.5 providing start of journey, passenger drop off/pickup, and end of journey location information needed by the VOM 201.1.2 and the OVS 202.1 and the in-vehicle Road Usage Accounting module 201.1.6

FIG. 2, Driver/Vehicle Registration—The party with legal responsibility for the care and operation of vehicle (the owner/manager 206) would register vehicles and drivers authorised to operate specific vehicle(s) 202.2. In the cases of most private cars the “owner” would be the principal driver. Registration would require providing name and address details (home, normal place of work) any security related codes and the telephone number of the driver's mobile phone. Access to this registration process 202.2 can be direct through the Vehicle Operations Support Centre 202 or indirect through the Road User Service Provider 204. Registration would be typically done via the Internet using either land line or wide area wireless connection.

FIG. 2, Vehicle Operations Support Centre (VOSC)—The VOSC 202 updates the Database of Registered Vehicles Road Users 205 with new driver/vehicle details or performs deletions are required. If the vehicle is new to the system the VOSC remotely commissions the vehicle to participate in the occupancy entitlement programme of the Road User Service Provider 204. This commissioning entails the provision to the SEC 201.1 of any security codes and SIM card codes for driver's Bluetooth mobile phone 203.1. Vehicles can also be de-commissioned. Authorised drivers can be added and deleted to commissioned vehicles as required by the vehicle owner/manager 206. All communications between the VOSC and the vehicle SEC are encrypted.

FIG. 2, Driver/Journey Authentication Module 201.1.4a—When an occupant (driver or passenger) is within a defined short range distance (measured in meters) of a parked vehicle with their switched on Bluetooth mobile phone 203.1, (303.1 FIG. 3), it is recognised by the Communications Gateway 201.1.1 and its unique identifier code (UIC) is passed to the Automatic Occupant Recognition (AOR) sub-module 201.1.4a.1. All UICs are transferred to the Authorised Driver Recognised (ADR) sub-module 201.1.4a.3 where they are compared with a list of registered drivers and regular passengers for that vehicle that is retrieved from the Memory module 201.1.3. UICs not on this list are treated as “guests”. Upon recognition of an authorised driver's mobile phone whilst the vehicle is in a parked condition the Authorised Driver Recognised (ADR) 201.1.4a.3 issues a command to the Vehicle Occupancy Manager (VOM sub-module) 201.1.2 to create the Occupant Manifest 201.1.2.1. If no authorised driver mobile phone is recognised when the journey commences as indicated by the Journey Detector sub-module 201.1.4a.2 the occupant manifest defaults to 1 (one) occupant for that journey irrespective of any passenger mobile phones that have been recognised. However, in other embodiments of this invention the occupant manifest may be declared with or without the recognition of an authorised driver's mobile phone.

FIG. 3, Regular Passenger Registration—In example embodiments of this invention, using their mobile phones 303.1 regular passengers in a vehicle would register 302.2 with the Vehicle Occupancy Verification Centre 302. This registration would be recorded in the database of Registered Vehicles and Road Users 305.1.

FIG. 3—For all Bluetooth mobile phones 303.1 detected by the AOR sub module 301.1.4b.1 which do not belong to an authorised driver of the vehicle, the assumption is made that they belong to vehicle passengers (either regular or guest). The positional movements of passenger mobile phones (one or more) that are detected by the AOR sub-module 301.1.4b.1 (immediate pre-journey, in-journey and immediate post journey) are passed from the Communications Gateway 301.1.1 to the Mobile Phone Signal Processor 301.1.4b.2 which analyses the signal strength and propagation from each Bluetooth mobile phone. The purpose of this analysis, which can be at centimetre levels of positional accuracy, is to detect suspicious movements out of character with normal passenger behaviour for approaching, entering, moving within and exiting a vehicle. Such suspicious movement suggests the possibility of fraudulent declaration of passengers. Also the position of the mobile phones relative to each other at any time can identify abnormal or questionable movement and/or positioning (see FIG. 4).

Each mobile phone recognised by the AOR sub-module is treated as a claim of passenger occupancy. The purpose of the Mobile Phone Signal Processor sub-module 301.1.4b.2 is to establish the veracity of each claim on a scale of confidence. Where the confidence level is very low and once the vehicle is travelling the Vehicle Occupancy Manager module 301.1.2 may send a prompt to the mobile phone(s) in question. The prompt would consist of discreet alert, inaudible to the driver, displaying a pin number in graphic format. The owner of the phone (i.e. the passenger) would be required to enter the pin number into the keypad of the mobile phone 303.1 within a specified number of second. Failure to do so could result in the occupancy claim being rejected. All other claims deemed as acceptable or provisionally acceptable are entered into the Occupant Manifest 301.1.2.1 together with the veracity confidence level. Supporting data for borderline cases is stored in the Memory module 301.1.3 for post journey analysis by the Occupancy Verification System 302.1 at the Vehicle Operations Support Centre 302. The process performed by the in vehicle Mobile Phone Signal Processor sub-module is termed, Level 1 Screening. The process performed by the Occupancy Verification System 302.1 is a more advanced Level 2 verification of borderline or suspicious cases identified by the Level 1 in-vehicle screening.

In-Journey Changes to Passenger Occupancy—During the journey, the SEC Communications Gateway 301.1.1 maintains a paired link with each Bluetooth mobile phone 303.1. If a Bluetooth mobile phone is switched off the pairing is broken and the mobile phone (i.e. passenger) is earmarked as a possible drop off. If however the phone is again switched on during the journey, the possible drop off status is revoked back to passenger being “present” when detected again by the AOR sub module 301.1.4b.1. In cases where the passenger is dropped off with their Bluetooth mobile phone switched on, the Mobile Phone Signal Processor module 301.1.4b.2 will track a fading signal, the propagation of which indicates a passenger departure. The Occupant Manifest 301.1.2.1 is time stamped and updated accordingly. In-journey passenger pickups are treated as described in paragraphs [0073] and [0074].

End of Journey Occupancy Declaration—At the end of the journey as occupants depart from the vehicle, the Mobile Phone Signal Processor 301.1.4b.2 tracks the fading signals of the Bluetooth mobile phones and annotates the Occupant Manifest 301.1.2.1 accordingly. The complete occupancy history for the journey: start of journey, in-journey passenger drop offs/pickups and passengers departed at end of journey is officially “declared” and stored in the Memory module 301.1.3 for subsequent communication to the Occupancy Verification System 302.1.

Road User Charging FIG. 2—The declared journey occupancy recorded in the Memory module 201.1.3 is available to any Road Usage Accounting (RUA) software applications 201.1.6 that may be installed in the SEC 201.1. RUA is not part of this invention and is mentioned for contextual reference only. Those practiced in the art will appreciate that occupancy data and road usage accounting will reference common journey and vehicle identifiers.

FIG. 4, —The Mobile Phone Signal Processor sub-module 401.1.4b.2 is middleware which is integrated within the Secure Embedded Computer 401.1. It performs the task of an intelligent positioning anchor node whereby the relative locations of surrounding mobile nodes (mobile phones) within communications range are periodically calculated throughout the course of each journey. The cluster of occupant mobile phones 403.N acts as an ad-hoc short range communication network in which relative locations of the mobile phones can be used to identify suspicious patterns of behaviour.

FIG. 4, Mobile Phone Ad-Hoc Positioning Network, 403.N —The accuracy of positioning through the use of short-range wireless communications is dependent upon the number of positioning nodes. Hence, in the example embodiment of this invention a positioning engine shall be downloaded onto the mobile phones themselves (providing an intelligent ad-hoc positioning network). The download of this application is envisaged to be completed through an over-the-air update either via Bluetooth or the GSM/GPRS Network. Upon execution of this application, each mobile phone device may identify distances to/from surrounding mobile phones, through which ultimately the respective locations of all mobile phones may be identified.

Occupancy Verification System (OVS), FIG. 5—The OVS 502.1 receives journey occupancy declarations from registered vehicles and where the confidence level of such declarations is not sufficient it applies more advanced methods to establish the veracity of the vehicle declared occupant manifest. The OVS acts as a second line of defence against fraudulent occupancy claims. Its concern is more with patterns of deception rather than with individual cases of purposeful wrongful declaration or isolated mistakes in the claim of occupancy. Where patterns of deceitful claims are suspected or established the Road User Service Provider 504 are notified for follow-up investigative action. Less serious cases may result in cautions and temporary suspension of occupancy related entitlements. Serious cases may result in legal proceedings against the perpetrator(s). The OVS can also perform random checks of vehicle occupancy declarations having a high confidence level.

Occupant Manifest Declarations in the higher band of confidence levels are “rubber stamped” by the OVC 502.1 and passed on to the Road User Service Provider 504 and Billing Services Provider 504. For those in the medium band of confidence a statistical sample may be set aside for further analysis. Those in the lower confidence band can earmarked for deeper scrutiny over an extended period of time. For example the OVC can use sub 50 meter accuracy localisation tools accurate to sub 50 meters to track the after-journey dispersal of occupant's mobile phones in a long range wireless network. The dispersal pattern for any journey (pre-selected or based on suspicious occupancy declaration by the vehicle SEC 501.1 or selected simply at random) can be assessed and compared to statistical norms for past journeys of the vehicle and/or statistically relevant populations of road users, vehicles or journeys. If a statistical pattern emerges from such post-journey analysis of a vehicle's occupant manifest declarations that appear as suspicious, the Road User Service Provider 504 can be notified to suspend occupancy related entitlements for the vehicle and take possible legal actions against the owner/manager/driver.

FIG. 6—This example embodiment of the invention uses Artificial Intelligence (AI) strategies to associate membership functions to the pattern of sequential events which constitute a journey. For example in a journey with 3 vehicle occupants there is a large probability that: When boarding, the doors will open at approximately the same time 603.1; occupants will move closer to each other as they take their seats followed by the door shut once the occupants are comfortable and stationary within the vehicle 603.2. Similar associations of membership functions can be applied to model probabilities of events for during and at the end of the journey: 603.2, 602.3, and 603.4 respectively.

Within the example embodiment of this invention, an approach using Neural Networks applying a Genetic Algorithm (GA) will be used to recognise cluster and classify relative mobile phone locations to probabilities associated with the journey event membership functions. A degree of association to each journey event shall hence be determined, upon which ultimately judgement can be made regarding the whether or not a fraudulent declaration regarding the number of passengers has been claimed vehicle driver.

Associated with each judgement of an occupancy declaration by the Vehicle Occupancy Manager 301.1.2 will be a confidence level determined by the Mobile Phone Signal Processor sub module 401.1.4b.2. This confidence level will determine the need for further scrutiny by the Occupancy Verification System 302.1

Within this example embodiment, it is envisioned that upon the unlocking of vehicle doors, relative locations between (i) the SEC and PNCs and, (ii) between the PNCs are calculated, and provided as inputs to the SEC upon which a behaviour pattern is identified.

The behaviour pattern to be identified is the composition of probabilities associated with consecutive actions, which are modelled in terms of relative locations of the PNCs (with respect to the SEC and each other) and relative time-intervals between associated actions. Each action will in turn have an association with a probability identifying the possibility of a fraudulent act and deviation from the norm. The SEC will provide a decision, based upon the observed patterns and notify the driver accordingly. The decision in this example embodiment utilises Neural Networks to detect such deviations from the norm.

The Neural Network genetic algorithm provides a data processing algorithm whereby behavioural pattern and its associated actions may be compared against previously observed/simulated behavioural patterns to distinguish conformity. The accuracy of the neural network depends upon the number of observed/simulated inputs which are provided to the genetic algorithm; and the accuracy of the simulations. Hence, for an accurate solution, prior to execution of the algorithm:

(i) The environment of the vehicle with respect to its propagation conditions is analysed and inputted into the genetic algorithm; and
(ii) At a generic level, human behaviour trends of interest are established.

Examples of the associated actions which constitute to a behavioural pattern are summarised below:

### Upon Boarding:

### Entry Behaviour:

Relative PNC movement model: Identifying patterns associated with movement of the PNCs around/towards the vehicle.
Door opening behaviour model: Identifying opening of doors and respective times associated with doors opening.

### Settling Behaviour:

Relative PNC movement model into seats: Identifying movement of PNCs doors and respective times associated with doors opening.
Door closing behaviour model: Identifying closing of doors and respective times associated with doors closing.

### In-Journey Behaviour:

Relative PNC movement model: Identifying movement of the PNCs whilst within the journey.

### Upon Exit:

### Alighting:

Relative PNC movement model: Identifying patterns associated with movement alighting from the vehicle.

Door opening behaviour model: Identifying opening of doors and respective times associated with doors opening.

### Dispersal:

Door closing behaviour model: Identifying closing of doors and respective times associated with doors closing.
Relative PNC movement model: Identifying patterns associated with movement of the PNCs around/away form the vehicle.

The association of the actions with a probability identifying the possibility of a fraudulent act and deviation from the norm, may be associated with other activities, or a combination such as the opening and closing of the passenger doors upon boarding may be combined with the opening and closing of the passenger doors upon exit when considering expected and/or suspicious behaviours.

This invention teaches (1) an economic and operationally practical method, apparatus and enabling processes to identify the relative locations of mobile phones to each other and to a vehicle as a means of determining vehicle occupancy; (2) mapping of vehicle journey event membership functions to relative occupant mobile phone location estimations; and (3) identification of suspicious position/movement patterns of mobile phones indicating suspicious behaviour (i.e. false occupancy claims to obtain road usage entitlements by illegal means).

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A secure method of verifying occupancy in a passenger transport conveyance, the method comprising the steps of:
(1) automatically declaring prior to the start of a journey the occupancy in a passenger transport conveyance;
(2) monitoring and assessing the location and movement pattern of passengers arriving prior to the start of the journey, during the journey and immediately after exiting the transport conveyance at the end of the journey; and
(3) identifying suspicious occupancy declarations, based on the monitoring and assessment of step (2).

2. The method of claim 1, further comprising the step of:
(4) adjusting automatically declared occupancy in response to suspicious occupancy identified at step (3).

3. The method of claim 1, wherein the step (2) further comprises monitoring and assessing the pattern of passenger geographic dispersals over some defined period after the end of the journey.

4. The method of claim 3, wherein the step (3) comprises verifying that the pre-journey/post journey passenger movement patterns are consistent with the automatically declared passenger occupancy.

5. The method of claim 1, further comprising the step of:
communicating the verified passenger occupancy for each journey to a transport system usage billing and accounting system.

6. The method of claim 1, wherein the step (1) is performed using local wireless communication between a personal nomadic communicator associated with each passenger and a secure embedded computer associated with the passenger transport conveyance.

7. The method of claim 1, wherein step (2) results in a passenger manifest, and the method further comprising transmitting the passenger manifest from the passenger transport conveyance to a remote occupancy verification system to perform step (3).

8. The method of claim 1, wherein the step (3) comprises identifying suspicious occupancy declarations, based on the monitoring and assessment of step (2) by detecting movement patterns of passengers as one or more of:
patterns which are always in close proximity;
patterns which never diverge concurrently from each other at the end of the journey; and
patterns which diverge at the end of the journey, with one passenger remaining stationary for a predetermined period of time.

9. The method of claim 1, comprising the further step of storing in a statistical database the movement pattern of passengers obtained in step (2).

10. The method of claim 1, wherein the step (3) comprises identifying suspicious occupancy declarations based on comparing monitored and assessed movement patterns against a stored statistical database of movement patterns.

11. The method of claim 1, wherein the step (3) comprises a first level of identifying, and wherein a second further level of identifying is performed in response to an occupancy declaration identified in step (3) as being above a suspicion threshold.

12. The method of claim 11, wherein the first level of identifying is performed based on information gathered at steps (1) and/or (2) using local wireless communication between a personal nomadic communicator associated with each passenger and a secure embedded computer associated with the passenger transport conveyance, and wherein the second level of identifying is performed based on information gathered at steps (1) and/or (2) using wireless communication between a personal nomadic communicator associated with each passenger, a secure embedded computer associated with the passenger transport conveyance and a long range wireless communications network.

13. A system operative to verify occupancy of a passenger transport conveyance, the system comprising:
(a) a personal nomadic communicator associated with each passenger;
(b) a secure embedded computer provided on the transport conveyance, and operable to verify occupancy of the passenger conveyance by the presence of personal nomadic communicators within the passenger conveyance; and
(c) an occupancy verification system operable to identify patterns of location and/or movement of personal nomadic communicators, and based on the identified patterns to provide a further verification of occupancy of the passenger transport conveyance based on the identified patterns.

14. (canceled)
